(19) United States
(12) Patent Application Publication
(10) Pub. No.: US 2007/0048117 A1
(43) Pub. Date: Mar. 1, 2007

(54) Systems, methods, and apparatus for moving and lifting objects with a lifting fork

(76) Inventor: Robert Joseph Lawless, Acworth, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/203,729

(22) Filed: Aug. 15, 2005

(51) Int. Cl. B66F 9/18

(52) U.S. Cl. 414/619

(57) ABSTRACT

The present invention relates to systems, methods, and apparatus for moving and lifting objects with a lifting fork. In one aspect of the invention, a system includes at least one fork and a detachable roller housing adapted to mount to the at least one fork. The detachable roller housing can include at least one upper roller capable of contact with an object, and at least one lower roller capable of contact with a portion of the at least one upper roller and a supporting surface. Rotation of the one lower roller causes rotation of the one upper roller with respect to the object. The detachable roller housing can also include a retaining device adapted to secure the at least one fork with respect to the detachable roller housing.

### FIELD OF THE INVENTION

The invention generally relates to lifting systems. More particularly, the invention relates to systems, methods, and apparatus for moving and lifting objects with a lifting fork.

### BACKGROUND OF THE INVENTION

Objects such as goods are stored and shipped throughout the world in relatively uniform size loads that rest on either pallets or thin plates of pasteboard or other fiber or plastic materials known as slip sheets. Conventional lift truck forks can be used to lift and move pallets or slip sheets bearing loads. Transfer of loads resting on pallets or slip sheets can be cumbersome using forks associated with such conventional devices since the loads on such pallets or slip sheets are sometimes difficult to slide on and off of the forks. There are numerous other drawbacks associated with these activities.

One solution involves permanently attaching a set of rollers to a conventional lifting fork. However, in some instances, permanently attached rollers limits the use of the lifting forks.

As a result, it is desirable to provide improved structures and techniques for transferring loads carried on slip sheets onto and off of lifting forks.

### SUMMARY OF THE INVENTION

The present invention comprises systems, methods, and devices for moving and lifting objects with a lifting fork. This invention permits a lifting fork to be adapted with a roller housing and a set of rollers. The roller housing and set of rollers can be coupled with the lifting fork when needed, and decoupled when not in use. When the roller housing and set of rollers are coupled with the lifting fork, the combined device can be used to transfer and elevate loads carried on slip sheets. The combined device provides an improved lifting fork that utilizes the set of rollers to assist transferring loads onto and off of the lifting fork. Decoupling the roller housing and set of rollers permits a user to use the lifting fork without the set of rollers or the roller housing.

In general, a system for moving and lifting a load includes a fork and a removable roller housing with a set of rollers. The fork can be associated with a fork lift or similar type of equipment. The roller housing is adapted to mount to the fork. The roller housing includes at least one upper roller capable of contact with a load or an object, and at least one lower roller capable of contact with a portion of the upper roller and a supporting surface. Rotation of the lower roller along the supporting surface causes rotation of the upper roller with respect to the load or object.

A particular method for moving and lifting an object relative to a supporting surface includes providing a fork. The method also includes mounting a roller housing to the fork. The roller housing, for example, includes at least one upper roller capable of contact with an object, and at least one lower roller capable of contact with a portion of the upper roller and a supporting surface. The method also includes securing the roller housing to the fork. Furthermore, the method includes positioning the at least one upper roller adjacent to the object. Rotation of the one lower roller against the supporting surface causes an opposing rotation of the upper roller with respect to the object.

A particular device for adapting a lifting platen to move and lift an object relative to a supporting surface includes a roller housing adapted to mount to at least one lifting platen. The roller housing includes one or more sets of rollers. Each set of rollers includes at least one upper roller capable of contact with an object, and at least one lower roller capable of contact with a portion of the at least one upper roller and a supporting surface. Rotation of one lower roller against the supporting surface causes an opposing rotation of one upper roller with respect to the object. In one embodiment, the roller housing can also include at least one retaining device adapted to secure the roller housing to the at least one lifting platen.

These above systems, methods, and device are mentioned not to limit or define the invention, but to provide examples of embodiments of the invention to aid understanding. Exemplary embodiments are discussed in the Detailed Description, and further description of the invention is provided there.

Objects, features and advantages of various systems, methods, and devices according to various embodiments of the invention include:

(1) moving and lifting objects with a lifting fork;

(2) moving and lifting an object relative to a supporting surface;

(3) using an apparatus for adapting a lifting platen to move and lift an object relative to a supporting surface;

(4) adapting a fork with a removable roller housing and set of rollers to move and lift an object relative to a supporting surface.

Other objects, features and advantages of various aspects and embodiments of systems, methods, and devices according to the invention are apparent from the other parts of this document.

### BRIEF DESCRIPTION OF THE DRAWINGS

These and other features, aspects, and advantages of the present invention are better understood when the following Detailed Description is read with reference to the accompanying drawings, wherein:

FIG. 1 is a perspective view of a roller housing and fork combination in accordance with one embodiment of the invention.

FIG. 2 is an overhead view of the roller housing and fork combination shown in FIG. 1.

FIG. 3 is a rear view of the roller housing and fork combination shown in FIGS. 1 and 2.

FIG. 4 is a front view of the roller housing and fork combination shown in FIGS. 1-3.

FIG. 5 is a side view of the roller housing and fork combination shown in FIGS. 1-4.

FIG. 6 is a top view of roller housing in accordance with another embodiment of the invention.

FIG. 7 is a side view of the roller housing shown in FIG. 6.

FIG. 8A-8D illustrate a method for mounting a roller housing to a fork in accordance with an embodiment of the invention.

FIG. 9A-9D illustrate another method for mounting a roller housing to a fork in accordance with another embodiment of the invention.

FIG. 10 illustrates an example of a roller for a roller housing in accordance with an embodiment of the invention.

FIG. 11 illustrates an example of lower roller-to-upper roller contact in accordance with an embodiment of the invention.

FIG. 12 illustrates another example of lower roller-to-upper roller contact in accordance with an embodiment of the invention.

FIG. 13 illustrates a series of rollers when an associated roller housing is elevated above a supporting surface in accordance with an embodiment of the invention.

FIG. 14 illustrates a series of rollers when an associated roller housing is positioned adjacent to and in substantial contact with a supporting surface in accordance with an embodiment of the invention.

FIG. 15 illustrates a series of rollers when a load is positioned on an upper surface of a roller housing, and the roller housing is positioned on a supporting surface in accordance with an embodiment of the invention.

FIG. 16 illustrates a flow diagram of a method in accordance with an embodiment of the invention; and

FIG. 17 illustrates a flow diagram of another method in accordance with another embodiment of the invention.

### DETAILED DESCRIPTION OF SPECIFIC EMBODIMENTS

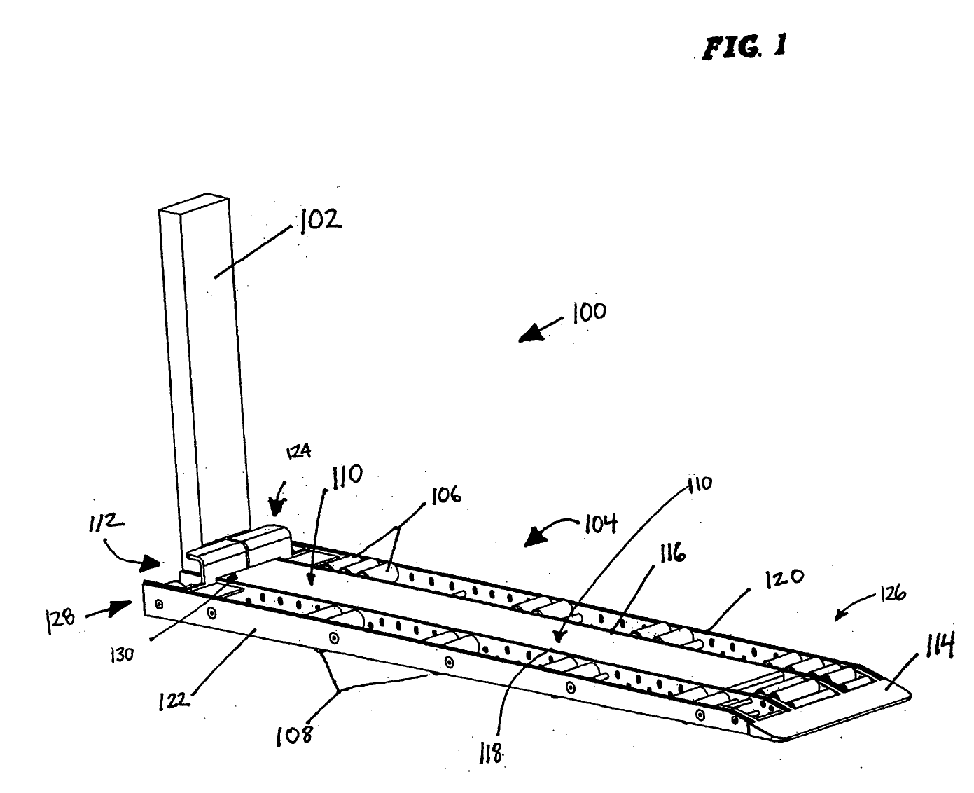

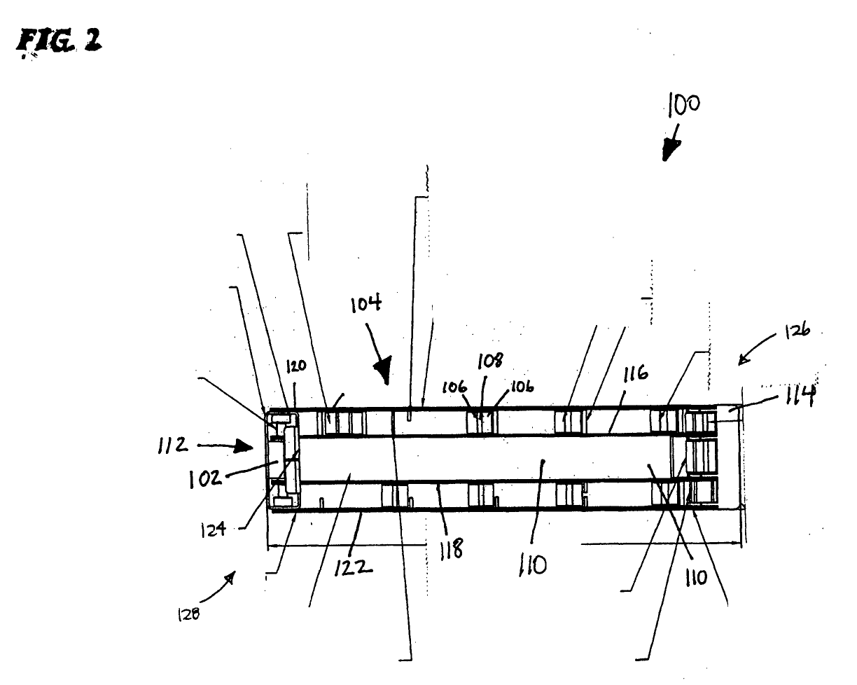

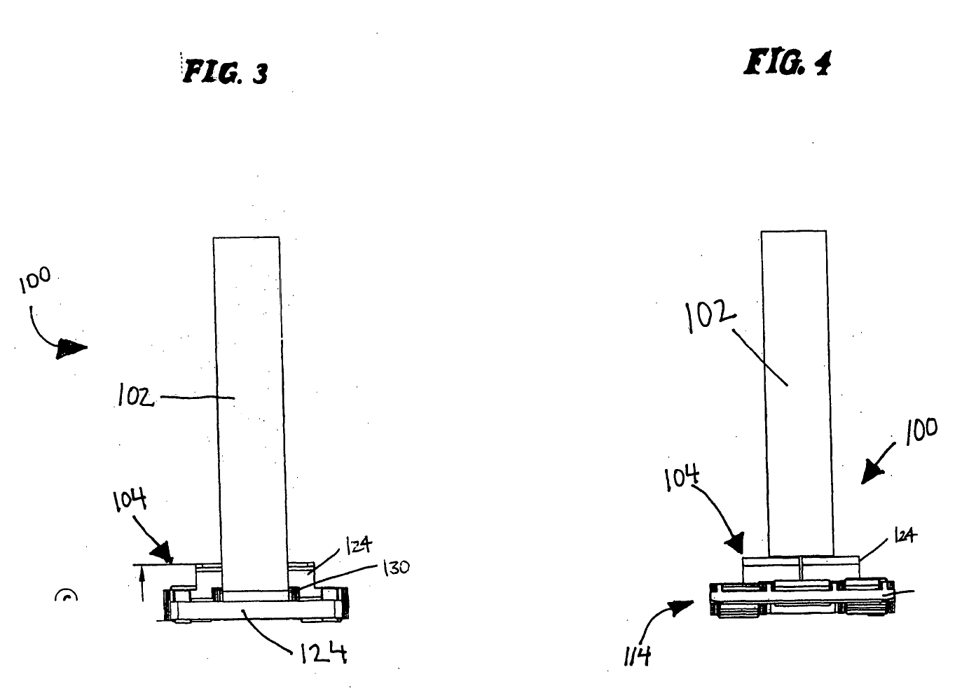

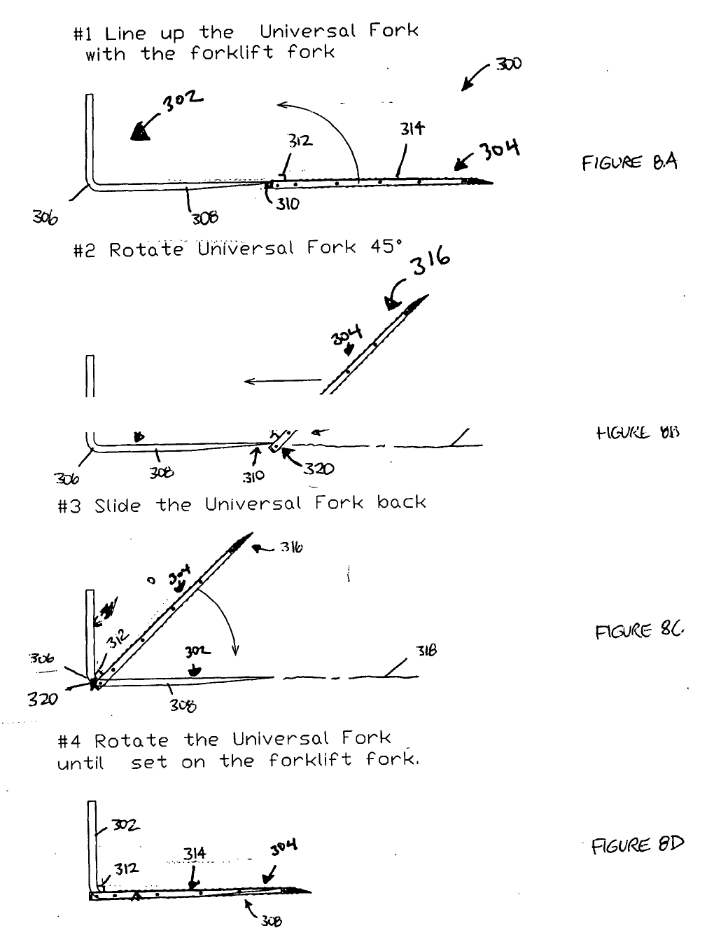

Referring now to the drawings in which like numerals indicate like elements throughout the several figures, FIGS. 1-17 are illustrations showing implementations of systems, methods, and an apparatus according to embodiments of the present invention. While the implementations shown each reflect a combined lifting fork device embodiment, other embodiments are possible. The combined lifting fork devices shown in FIGS. 1-5, and FIGS. 6-7 as 100 and 200 respectively, are for moving and lifting goods such as a load on a slip sheet. Methods, such as those illustrated in FIGS. 8A-8D, 9A-9D, 13, 14, 15, 16, and 17, according to the invention may be performed with the systems 100, 200 shown.

This invention permits a lifting fork to be equipped or otherwise adapted with an apparatus such as a roller housing with a set of rollers. The roller housing and set of rollers can be coupled with the lifting fork when needed, and decoupled when not in use. When the roller housing and set of rollers are coupled with the lifting fork, the system or combined lifting fork device can be used to transfer loads carried on slip sheets. The invention enables loads such as slip sheet mounted loads to be transferred, for instance, from the floor to a roller conveyor by providing a structure that improves a wide platen fork for a fork lift, pallet fork jack, or other lifting device. When the system or combined lifting fork device is initially placed on and moved into a position adjacent to and beneath a slip sheet mounted load, the combined lifting fork device provides roller contact with the floor (or other supporting surface) and at least a portion of the underside of the slip sheet or load. The system or combined lifting fork device also provides frictional contact between at least a portion of the underside of the slip sheet or load when the slip sheet or load is elevated above the floor (or other supporting surface) from the initial position, or alternatively when the slip sheet is lowered towards the floor (or other supporting surface) from an elevated position. In this manner, the system or combined lifting fork device provides movement and lift for a slip sheet mounted load from the floor (or other supporting surface) to an adjacent roller conveyor system, or vice-versa.

The system 100 or combined lifting fork device shown in FIGS. 1-5 includes a fork structure 102, and a detachable roller housing 104 with a set or rollers, such as a series of upper rollers 106 and lower rollers 108. The detachable roller housing 104 of the invention can be mounted to or otherwise connected with an existing lifting device, such as a lifting fork 102 or lifting platen associated with a fork lift or pallet fork jack that has a conventional fork structure such as a wide platen fork. In one embodiment, a conventional lifting device can be equipped with a pair of detachable roller housings 104, one for each fork structure 102 of the lifting device. A detachable roller housing 104 can be mounted to each fork structure 102.

As shown in FIG. 1, the fork structure 102 can be a relatively thin and elongated structure with a blade, not shown but hidden by an upper surface 110 of the roller housing 104, and a root 112. The blade can be oriented substantially horizontal with respect to the root 112, thus the blade and the root 112 together form a L-shaped structure. The blade can be positioned adjacent to at least one end of the roller housing 104, and adjacent to and beneath the upper portion 110 of the roller housing 104.

The embodiment shown in FIG. 1 includes a detachable roller housing 104 with a tapered point 114, a set of central tracks 116, 118 and a set of outer tracks 120, 122, a series of upper rollers 106, series of corresponding lower rollers 108, and an angled retaining component 124.

The roller housing 104 can have a tapered point 114 adapted for sliding beneath and immediately adjacent to a load such as a slip sheet mounted load. The tapered point 114 can be mounted adjacent to an end of the roller housing 104, such an opposing end 126 to an end 128 adjacent to the fork structure 102. The tapered point 114 can be a detachable and replaceable part, and can be made from steel or a synthetic material. Other durable materials can be utilized for other embodiments of a tapered point 114.

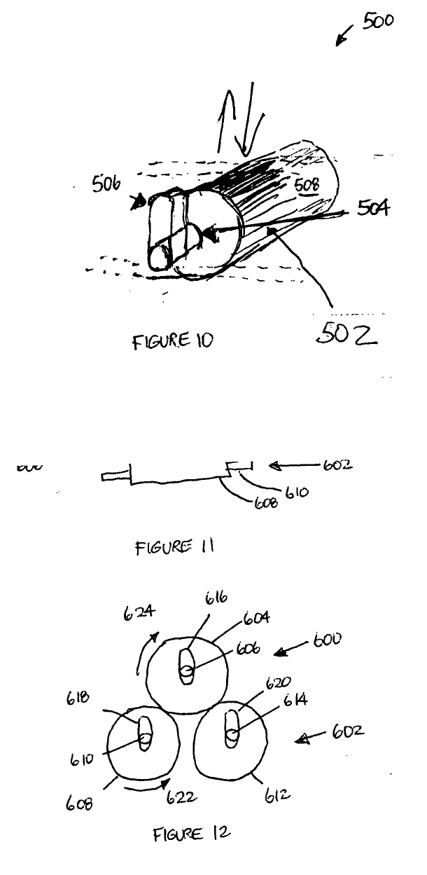

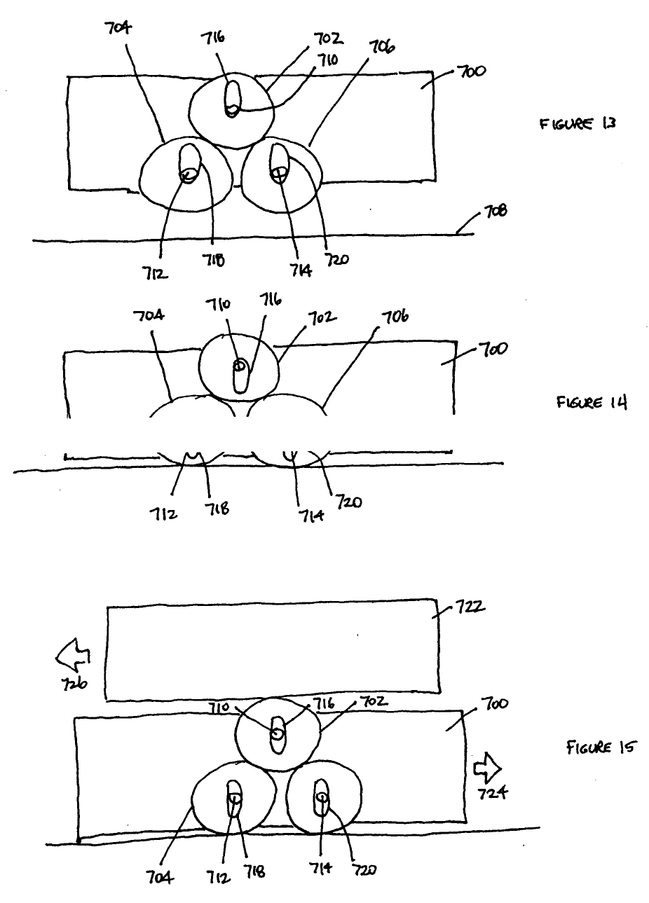

The detachable roller housing 104 can include a set of central tracks 116, 118 aligned, for example, in a substantially parallel orientation with an extended portion of the fork structure 102. The central tracks 116, 118 can be aligned with a corresponding set of outer tracks 120, 122 also aligned, for example, in a substantially parallel orientation with an extended portion of the fork structure 102. Together, the set of central tracks 116, 118, and set of outer tracks 120, 122 can provide fixed support for some or all of the upper rollers 106 and lower rollers 108. The detachable roller housing 104 can support the upper rollers 106 and lower rollers 108 within respective slots associated with the tracks 116, 118, 120, 122 so that the upper rollers 106 and lower rollers can slide upward and downward relative to the detachable roller housing 104. For example, the upper rollers 106 can slide upward and downward within the slots; and likewise, the lower rollers 108 can also slide upward and downward within respective slots. Examples of slots are shown and described with respect to FIGS. 10, 12, and 13A-13C. Depending on the position of the fork structure 102, the upper rollers 106 and lower rollers 108 are generally in substantial upper roller-to-lower roller contact (hereinafter “roller-to-roller contact”). When the upper rollers 106 and lower rollers 108 are in roller-to-roller contact, some or all of the upper rollers 106 can rotate in an opposing direction to the rotation of the corresponding lower rollers 108. For example, when there is roller-to-roller contact, some or all of the upper rollers 106 can rotate in a clockwise direction when the corresponding lower rollers 108 rotate in a counter-clockwise direction. Examples of rollers in substantial roller-to-roller contact are shown in FIGS. 11, 12, 13A-13C described in greater detail below.

In the embodiment shown in FIG. 1, each of the respective upper rollers 106 and lower rollers 108 can rotate on its own respective axle, the ends of which are positioned within a respective vertically-oriented slot, examples shown in FIGS. 10, 12, and 13A-13C. The vertically-oriented slots can be machined into or otherwise formed in the lateral sides of the roller housing 104, such as the lateral sides of the set of central tracks 116, 118 and the set of outer tracks 120, 122. The upper rollers 106 and lower rollers 108 can be steel rollers with an optional frictional coating on the external portion of the rollers. Such a coating enhances friction between the roller surface and things contacted by the rollers. In other embodiments of the invention, the coating can be natural or synthetic rubber among other things.

Each roller and axle combination for the upper rollers 106 and lower rollers 108 can be a conventional roller and axle combination used in conventional conveyor-type systems. Other dimensions, widths, shapes, configurations, and combinations of upper rollers 106 and lower rollers 108 can be used in accordance with embodiments of the invention. For example, the invention can be utilized with wider rollers in the front than in the rear of the roller housing 104, and vice versa.

As shown in FIG. 1, an angled retaining component 124 can be mounted adjacent to one end 128 of the detachable roller housing 104. The angled retaining component 124 can be adapted to facilitate mounting of the blade associated with a fork structure, such as 102, with the detachable roller housing 104. An open portion 130 of the roller housing 104 adjacent to one end 128 of the roller housing 104 and the angled component can permit a user to mount the blade to a portion of the roller housing 104. An associated method for mounting a roller housing, such as 104, to a fork structure, such as 102, is illustrated in FIGS. 8A-8D. In other embodiments, a detachable roller housing 104 can be secured, attached, or connected to an existing lifting device such as a fork structure associated with a conventional fork lift.

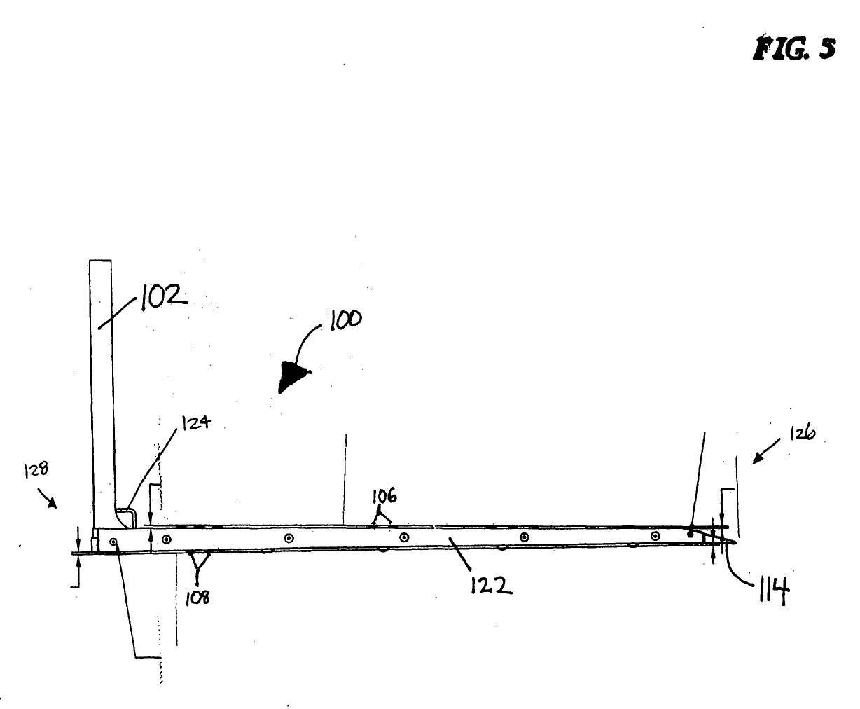

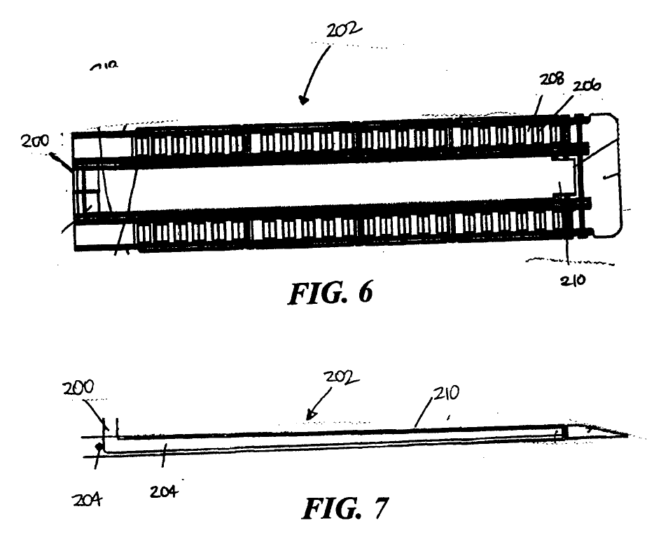

In another example, in the roller housing embodiment shown in FIG. 6, a fork structure 200 can be secured to a detachable roller housing 202 through the use of at least one retaining device, such as a pin 204. After the fork structure is mounted to the detachable roller housing 202, a pin 204 can be inserted into a portion of the detachable roller housing 202 to secure the roller housing 202 to the fork structure 200. A retaining device, can include, but is not limited to, a retaining bolt, a coupling, or a connector. When the combined fork structure 200 and roller housing 202 are not in use, the retaining device 204 can be removed, and the roller housing 202 can be detached from the fork structure 200. In that instance, the roller housing 202 can be stored separately and apart from the fork structure 200.

When the system 100 or combined lifting fork device is not supporting a load but is oriented at an elevated position, the upper rollers 106 and lower rollers 108 can rotate separate and independent from each other. However, in most instances when the system 100 or combined lifting fork device is in an elevated and unloaded position, the weight of the upper rollers 106 causes the upper rollers 106 to slide downward within the vertically-oriented slots, causing a lower portion of the upper rollers 106 to contact an upper portion of the lower rollers 108, thus creating substantial roller-to-roller contact.

From the elevated position and unloaded position, the system 100 or combined lifting fork device can be lowered to the floor, firm surface, or other supporting surface by the fork lift. When the lower rollers 108 contact the floor such as a supporting surface, the lower rollers 108 slide upward within the slots and with respect to the roller housing 104, and an upper portion of each lower roller 108 further contacts a lower portion of an upper roller 106. In this manner, when the system 100 or combined lifting fork device is moved in a (forward) direction along the floor or supporting surface towards a load, the contact with the floor or supporting surface causes the lower rollers 108 to rotate in a counterclockwise direction, and the roller-to-roller contact causes the upper rollers 106 to rotate in an opposing clockwise direction.

The system 100 or combined lifting fork device can then be positioned immediately beneath and adjacent to a load such as a slip sheet mounted load. This is accomplished by initially placing the tapered point 114 of the roller housing 104 beneath the load and moving the fork structure 102 towards the load so that the tapered point 114 is immediately beneath and adjacent to the load. As the combined lifting fork device is positioned adjacent to and beneath the load, the lower rollers 108 continue to rotate in a counterclockwise direction along the floor or supporting surface with the forward movement of the lifting fork beneath the load. The roller-to-roller contact continues to cause the upper rollers 106 to rotate in an opposing clockwise direction. As the load comes into contact with the upper rollers 106, the upper rollers 106 slide downward slightly within the slots of the roller housing 104 so that frictional contact is created between the load and a portion of the upper rollers 106 and/or a portion of the upper surface 110 of the roller housing 104. In this manner, the rotation of some or all of the upper rollers 106 assists the moving of the load onto the upper rollers 106 and/or a portion of the upper surface 110 of the roller housing 104, and the system 100 or combined lifting fork device can support a load.

As described above and shown in FIGS. 1 and 5, roller-to-roller contact between the lower rollers 108 and upper rollers 106 causes the upper rollers 106 to rotate in an opposing direction to the rotational direction of the lower rollers 108. In this manner, backward movement of the lifting fork along the floor or supporting surface, causes clockwise rotation of the lower rollers 108. This creates a counter-clockwise rotation of the upper rollers 106. When a load is supported by a portion of the upper rollers 106 and/or a portion of the upper surface 110 of the roller housing 104, the counter-clockwise rotation of the upper rollers assists with moving a load away from the upper rollers 106 and/or a portion of the upper surface 110 of the roller housing 104. In this manner, a system 100 or combined lifting fork device can be unloaded. Depending on the drawing view, the rollers 106, 108 may rotate in the opposite directions as indicated above but consistent with the functionality described above.

When the system 100 or combined lifting fork device is elevated with a load supported by the upper rollers 106 and/or a portion of the central set of tracks 116, 118 and/or a portion of the outer set of tracks 120, 122 of the roller housing 104, the lower rollers 108 will lose contact with floor or supporting surface. This permits the lower rollers 108 and upper rollers 106 to further slide downward within their respective slots of the roller housing 104. In this manner, the load settles on the upper portion of the roller housing 104, thus stabilizing the load on the combined lifting fork device during lifting and transporting of the load.

FIGS. 6 and 7 illustrate a system or combined lifting fork device in accordance with another embodiment of the invention. The combined lifting fork device shown in FIGS. 6 and 7 includes a fork structure 200, a detachable roller housing 202 with a retaining device 204 and a set or rollers, such as a series of lower rollers 206 and upper rollers 208. Similar to the roller housing in FIG. 1, the roller housing 202 shown can include an upper portion 210 to support the fork structure 200. The detachable roller housing 204 of the invention can be mounted to or otherwise connected with an existing lifting device, such as a lifting fork or platen fork associated with a fork lift or pallet fork jack that has a conventional fork structure such as a wide platen fork.

FIGS. 8A, 8B, 8C, and 8D illustrate an installation or mounting process that can be implemented with a system or combined lifting fork in accordance with an embodiment of the invention. For example, the process shown can be implemented with the system 100 or combined lifting fork of FIGS. 1-5. In another example, the process shown can be implemented with the system or combined lifting fork shown in FIGS. 6 and 7.

FIG. 8A illustrates a side view of a system 300, with an initial positioning of a fork 302 with respect to a detachable roller housing 304. The fork 302 can be similar to 102 shown in FIG. 1, and can include a root 306, a blade 308., and a tip 310. The roller housing 304 can be similar to 104 shown in FIG. 1, and can include an angled retaining component 312. As shown, the detachable roller housing 304 can be positioned in close proximity and adjacent to the lifting fork 302. Initially, the tip 310 of the fork 302 can be positioned adjacent to an angled retaining component 312 of the roller housing 304. As shown in subsequent FIGS. 8B, 8C, and 8D, the root 306, blade 308 and tip 310 associated with the fork 302 can be advanced with respect to the roller housing 304, and the blade 308 and tip 310 can be positioned beneath or adjacent to an upper portion 314 of the roller housing 304.

FIG. 8B illustrates an end such as a leading end 316 of the detachable roller housing 304 being pivoted with respect to a horizontal axis 318 associated with the blade 308 of the lifting fork 302 while maintaining the angled retaining component 312 of the roller housing 304 adjacent to the tip 310 of the fork 302. As FIG. 8C illustrates, the detachable roller housing 304 can then be mounted to the blade 308 of the lifting fork 302 by inserting the tip 310 of the fork 302 through an open portion 320 of the roller housing 304 adjacent to a trailing or opposing end 322 of the roller housing 304. The detachable roller housing 304 then mounts to the blade 306 by either advancing a greater portion of the blade 308 through the open portion 320 of the roller housing 304, or advancing the open portion 320 of the roller housing 304 over a greater portion of the blade 308, or both, while maintaining the leading end 316 of the roller housing 304 at an angle with respect to the horizontal axis 318 associated with the blade 308 of the lifting fork 302.

Thus, FIG. 8C illustrates the roller housing 304 and lifting fork 302 in substantially advanced positions with respect to each other while maintaining the leading end 316 of the roller housing 304 at an angle with respect to the horizontal axis 318 associated with the blade 308 of the lifting fork 302. In this position, the root 306 of the fork 302 is adjacent to the angled retaining component 312 of the roller housing 304. The root 306 acts as a physical stop for further advancement of the angled retaining component 312 of the roller housing 304 with respect to the blade 308 or fork 302. As shown in FIGS. 8C and 8D, the leading end 316 of the roller housing 304 can be rotated downward towards the horizontal axis 318 associated with the blade 308 to the installed position shown in FIG. 8D.

Thus, FIG. 8D illustrates the roller housing 304 fully mounted or otherwise installed to the fork 302. As the roller housing 304 is rotated downward as shown in FIG. 8C, some or all of the upper portion 314 of the roller housing 304 is lowered over an upper portion of the fork 302 until the blade 308 is adjacent to the lower side of the upper portion 314 of the roller housing 304. When the roller housing 304 is fully mounted to the lifting fork 302, as shown in FIG. 8D, the combined fork and roller housing assembly can then be used to move and/or lift a load from the ground in accordance with an embodiment of the invention.

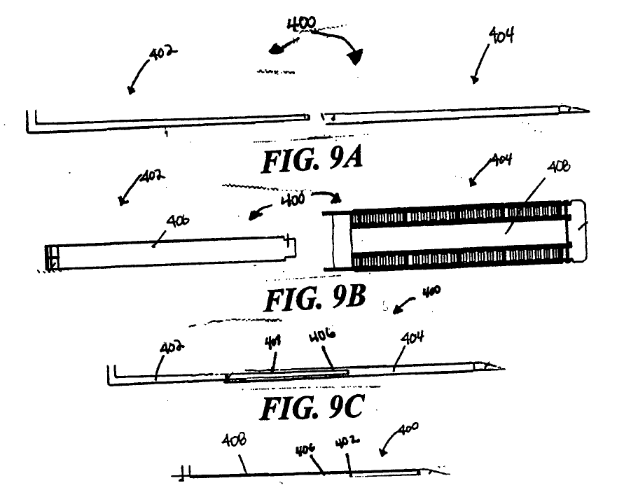

FIGS. 9A, 9B, 9C, and 9D illustrate an installation or mounting process for a system or combined lifting fork in accordance with another embodiment of the invention. For example, the process illustrated can be implemented with the system or combined lifting fork shown in FIGS. 6 and 7. FIG. 9A illustrates a side view of disassembled system 400, and FIG. 9B illustrates a top view of the initial positioning of the components shown in FIG. 9A. FIGS. 9A and 9B illustrate an initial position of a fork 402 with respect to a detachable roller housing 404. The fork 402 can be similar to the fork structure 200 shown in FIGS. 6 and 7, and the roller housing 404 can be similar to the roller housing 202 shown in FIGS. 6 and 7. In the embodiment shown in FIGS. 9A and 9B, the fork 402 and detachable roller housing 404 are separate and individual structures.

FIG. 9C illustrates the mounting of the roller housing 404 to the lifting fork 402. As shown, the detachable roller housing 404 can be positioned in close proximity and adjacent to the lifting fork 402. A blade portion 406 of the lifting fork 402 can be advanced with respect to a corresponding portion 408 of the roller housing 404 until a sufficient amount of the blade portion 406 is adjacent to or otherwise in contact with a portion of the roller housing 404. In the embodiment shown, the upper surface of the blade portion 406 is in substantial contact with the lower surface of an upper portion 408 of the roller housing 404.

As shown in FIG. 9D, the position of the roller housing 404 is substantially advanced with respect to the position of the fork 402. In the embodiment shown, the combined lifting fork 402 and roller housing 404 assembly can be used to lift and move a load such as a slip sheet mounted load. Once the blade portion 406 of the lifting fork 402 has been substantially advanced with respect to the detachable roller housing 404, the position of the fork 402 with respect to the roller housing 404 can be secured by a retaining device, for example, a retaining bolt 410. A retaining device such as retaining bolt 410 can prevent or otherwise inhibit the roller housing 404 from detaching or otherwise disengaging from the blade portion 406 of the fork 402 during use or movement. Other retaining devices and/or methods of mounting, securing, attaching, or otherwise connecting the detachable roller housing 404 to the blade portion 406 of the lifting fork 402 can be utilized in accordance with various embodiments of the invention.

FIG. 10 illustrates a roller assembly in accordance with an embodiment of the invention. A single roller assembly 500 is shown in FIG. 10. The roller assembly 500 can include a roller 502, axle 504, and slot 506 associated with a roller housing 508. As shown in FIG. 10, a roller 502 mounts to a respective axle 504. The axle 504 can be held in a substantially horizontal position as shown by the slot 506. An opposing slot and axle (not shown) can exist at an opposing end (not shown) of the roller 502. For example, the axle 504 can extend longer than the roller 502, and can protrude from each end of the roller 502. The roller 502 can rotate in both directions with respect to the axle 504. The slot 506 can be a vertically-oriented slot machined in a portion of the roller housing, such as tracks 116, 118, 120, 122 shown in FIG. 1, and allow the combined axle 504 and roller 504 assembly to move vertically up and down, depending upon the forces applied to the roller surface 508 of the roller 504.

FIGS. 11 and 12 illustrate examples of rollers for an embodiment of a roller housing in accordance with the invention. FIG. 11 is a front view of a series of upper rollers 600 and a series of lower rollers 602 in continuous upper roller-to-lower roller contact. FIG. 12 is a side view of a series of the upper rollers 600 and lower rollers 602 shown in FIG. 11. As shown in FIG. 11, each series of upper rollers 600 includes at least one upper roller 604 with a corresponding axle 606. Likewise, each series of lower rollers 602 includes at least one lower roller 608 with a corresponding axle 610. As shown in FIG. 12, the series of upper rollers 600, series of lower rollers 602, 612 and corresponding axles 606, 610, 614 can pivot within respective slots 616, 618, 620 for each respective roller and axle combination.

Furthermore, rotation of a series of upper rollers can be coordinated with the rotation of a series of lower rollers. In the series of upper rollers 600 shown in FIG. 12, an upper roller 604 cooperates with each corresponding lower roller 608, 612 so that when the lower rollers 608, 612 rotate in one direction 622, the corresponding upper roller 604 rotates in an opposing direction 624. Likewise, if the upper roller 604 rotates in a particular direction 622, the lower rollers 608, 612 rotate in an opposing direction 624. Note that in the example shown, the lower rollers 608, 612 are shown rotating in a counter-clockwise direction 622 and the upper roller 604 is shown rotating in a clockwise direction 624. In other instances, the lower rollers 608, 612 can rotate in a clockwise direction, and the corresponding upper roller 604 can rotate in a counter-clockwise direction.

In addition, a series of respective vertically-oriented slots 616, 618, 620 are shown in FIG. 12. In this example, the axle 606 of the upper roller 604 can slide in a substantially vertical direction within slot 616. The axles of 610, 614 of the lower rollers 608, 612 can also slide in a substantially vertical direction within respective slots 618, 620. As shown in this example, when the axle 606 of the upper roller 604 slides to a lower position within the slot 616, the axles 610, 614 of the lower rollers 608, 612 also slide to lower positions within respective slots 618, 620. Alternatively, when the axle 606 of the upper roller 604 slides to an upper position within the slot 616, the axles 610, 614 of the lower rollers 608, 612 also slide to upper positions within respective slots 618, 620. Other configurations for slots and axle arrangements, directions of movement, or other devices permitting coordinated movement of a series of upper rollers and a series of lower rollers can be utilized in accordance with other embodiments of the invention.

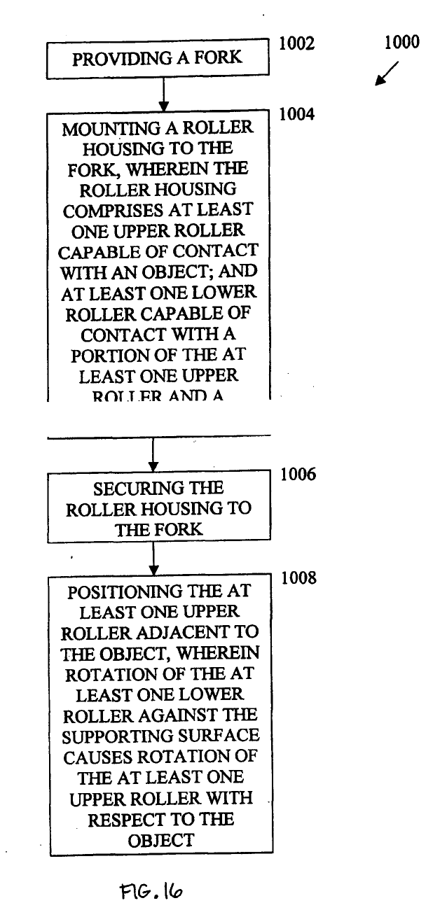

FIGS. 13, 14, and 15 illustrate various operations which can be performed by an embodiment of a roller housing in accordance with the invention. These operations are shown by way of example, and merely illustrate the relative movement and positions of a combination of an upper roller with respect to two lower rollers. Other relative movements and positions of rollers can be obtained in accordance with other embodiments of the invention.

In each operation shown, a roller housing 700 with a series of upper rollers 702 and corresponding series of lower rollers 704, 706 can operate with respect to a supporting surface such as the ground 708. For example, FIG. 13 illustrates a roller housing 700 positioned above the ground 708. In this example, the roller housing 700 can be positioned above the ground 708 or other supporting surface. When housing 700 is lifted or otherwise elevated above the ground 708, the lower rollers 704, 706 will lose substantial contact with the ground 708. As the weight of the upper rollers 702 and lower rollers 704, 706 combine with the force of gravity, the upper roller 702 and corresponding axle 710 begin to slide downward within and towards a lower portion of slot 716. Likewise, the lower rollers 704, 706 and corresponding axle 712, 714 also begin to slide downward within and towards lower portions of respective slots 718, 720. In this example, the weight of the upper rollers 702 and lower rollers 704, 706, combined with the force of gravity, causes the respective axles 710, 712, 714 associated with the upper rollers 702 and lower rollers 704, 706 to slide downward within the respective slots 716, 718, 720. When the axles 712, 714 of the lower rollers 704, 706 are in a lower portion of the respective slots 718, 720, portions of the lower rollers 704, 706 protrude from the lower portion of the roller housing 700.

In at least one embodiment, a portion of the upper roller 702 can protrude slightly above the upper portion of the roller housing 700 when the roller housing is elevated above the ground 708 or supporting surface. In other embodiments, the upper roller 702 can retract within the roller housing 700 when the roller housing is elevated above the ground 708 or supporting surface. In some embodiments, the protrusion and retraction of the upper roller 702 and lower rollers 704, 706 will be dependent on the orientation of the slots 716, 718, 720, size of the roller housing 700, and sizes of the rollers 702, 704, 706.

In the operation shown in FIG. 14, the roller housing 700 can be positioned immediately adjacent with and in substantial contact with the ground 708 or other supporting surface. When the housing 700 is lowered onto or otherwise positioned in substantial contact with the ground 708, some or all of the lower rollers 704, 706 can make substantial contact with the ground 708. In the example shown in FIG. 14, as the lower rollers 704, 706 contact the ground 708, the axles 712, 714 of the lower rollers 704, 706 slide upward within the respective slots 718, 720. The upward movement of the lower rollers 704, 706 forces the upper roller 702 upward and the corresponding axle 710 of the upper roller 702 begins to move upward within respective slot 716. As shown in this example, a portion of the upper roller 702 protrudes from an upper portion of the roller housing 700, and upper roller 702 can support a load slightly above or adjacent to the upper portion of the roller housing 700 when the upper roller 702 is maintained in the approximate position shown.

In at least one embodiment, the portions of the lower rollers 704, 706 can protrude from the lower portion of the roller housing 700 when the roller housing 700 is positioned in substantial contact with the ground 708 or supporting surface. In other embodiments, the lower rollers 704, 706 can retract within the roller housing 700 when the roller housing 700 is positioned in substantial contact with the ground 708 or supporting surface. In some embodiments, the protrusion and retraction of the upper roller 702 and lower rollers 704, 706 will be dependent on the orientation of the slots 716, 718, 720, size of the roller housing 700, and sizes of the rollers 702, 704, 706.

In the operation shown in FIG. 15, the roller housing 700 can be positioned immediately adjacent with and in substantial contact with the ground 708 or other supporting surface. Furthermore, a load 722 can be positioned above the roller housing 700 and immediately adjacent to the upper roller 702. In the example shown in FIG. 15, when both a load 722 is positioned immediately adjacent to the upper roller 702, and the lower rollers 704, 706 are positioned in substantial contact with the ground 708, the axles 712, 714 of the lower rollers 704, 706 and the axle 710 of the upper roller 702 slide to an intermediate or equilibrium position within the respective slots 716, 718, 720. As shown in this example, a portion of the upper roller 702 protrudes from an upper portion of the roller housing 700 to support a load slightly above or adjacent to the upper portion of the roller housing 700, and portions of the lower rollers 704, 706 protrude from a lower portion of the roller housing 700 to support the roller housing 700 slightly above the ground 708 or supporting surface when the lower rollers 704, 706. In this orientation, the roller housing 700 can be propelled by the lower rollers 704, 706 in one direction such as 724, while the load 722 is propelled by the upper roller 702 in an opposing direction 726.

The movement of the load 722 in an opposing direction from the movement of the roller housing 700 can be achieved by the roller-to-roller contact illustrated in FIG. 15. As the roller housing 700 moves in one direction, such as 724, the lower rollers 704, 706 maintain substantial contact with the ground 708 and rotate in one direction, such as a clockwise direction 728 on their respective axles 712, 714. Since the lower rollers 704, 706 maintain substantial contact with the upper roller 702, the rotation of the lower rollers 704, 706 transmits a rotational force to upper roller 702, thereby rotating the upper roller in an opposing direction, such as a counterclockwise direction 730 on axle 710. The rotation of the upper roller 702 transmits a force to the load 722 adjacent to and in substantial contact with the upper portion of the upper roller 702. The transmitted force from the upper roller 702 causes the load to move adjacent to the upper portion of the roller housing 700 in the opposing direction 726 to the direction 724 of movement associated with the roller housing 700.

FIG. 16 illustrates an exemplary method 1000 that provides a method for moving and lifting an object relative to a supporting surface. This exemplary method is provided by way of example, as there are a variety of ways to carry out methods according to the present invention. The method 1000 shown in FIG. 16 can be performed by any of various systems. The method 1000 is described below as carried out by the system 100 shown in FIGS. 1-5 by way of example, and various elements of the system 100 are referenced in explaining the example method of FIG. 16.

Referring to FIG. 16, the example method 1000 begins at block 1002, in which a fork is provided. For example, a fork such as a fork structure 102 in FIG. 1 can be provided.

Block 1002 is followed by block 1004, in which a roller housing is mounted to the fork, wherein the roller housing comprises at least one upper roller capable of contact with an object, and at least one lower roller capable of contact with a portion of the at least one upper roller and a supporting surface. For example, a roller housing such as the roller housing 104 shown in FIG. 1 can be provided. As described above, the roller housing 104 can include a set of upper rollers 106 adapted to contact an object such as a load. The roller housing 104 can also include a set of lower rollers 108 capable of contacting at least one of the upper rollers 106 and further capable of contacting a floor or supporting surface.

Block 1004 is followed by block 1006, in which the roller housing is secured to the fork. In the embodiment shown, the method illustrated in FIGS. 8A-8D can be utilized to secure the roller housing to the fork. In another example, a retaining device such as bolt 912 shown in FIG. 9D can facilitate securing a roller housing 104 to a fork structure 102. Other methods or types of retaining devices and/or methods for mounting, securing, attaching, or otherwise connecting a roller housing to a lifting fork can be utilized in accordance with various embodiments of the invention

Block 1006 is followed by block 1008, in which the at least one upper roller is positioned adjacent to the object, wherein rotation of the at least one lower roller against the supporting surface causes rotation of the at least one upper roller with respect to the object. In one example shown in FIG. 1, the set of upper rollers 106 and set of lower rollers 108 are capable of roller-to-roller contact, where the rotation of a lower roller causes a corresponding upper roller to rotate in an opposing direction.

At block 1008, the method 1000 ends.

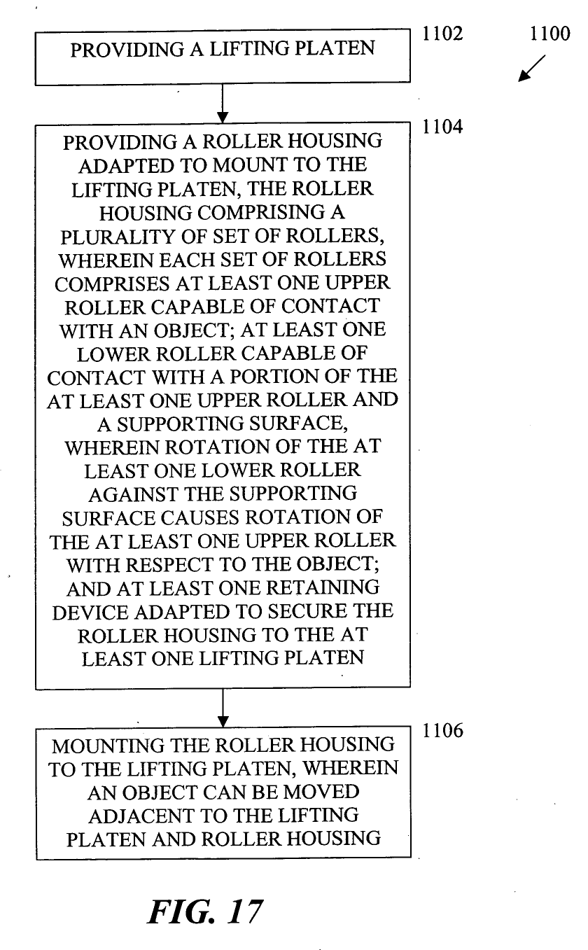

FIG. 17 illustrates a method for using an apparatus for adapting a lifting platen to move and lift an object relative to a supporting surface. This exemplary method is provided by way of example, as there are a variety of ways to carry out methods according to the present invention. The method 1000 shown in FIG. 17 can be performed by any of various systems. The method 1000 is described below as carried out by the system 100 shown in FIGS. 1-5 by way of example.

The method 1100 begins at block 1102, in which a lifting platen is provided.

Block 1102 is followed by block 1104, in which a roller housing adapted to mount to the lifting platen is provided. For example, a roller housing can include a plurality of sets of rollers, wherein each set of rollers can include at least one upper roller capable of contact with an object; and at least one lower roller capable of contact with a portion of the one upper roller and a supporting surface. In one embodiment, rotation of the lower roller against the supporting surface causes rotation of the one upper roller with respect to the object. The roller housing in this example can also include at least one retaining device adapted to secure the roller housing to the at least one lifting platen.

Block 1104 is followed by block 1106, in which the roller housing is mounted to the lifting platen, wherein an object can be moved adjacent to the lifting platen and roller housing.

In block 1106, the method 1100 ends.

While the above description contains many specifics, these specifics should not be construed as limitations on the scope of the invention, but merely as exemplifications of the disclosed embodiments. Those skilled in the art will envision many other possible variations that are within the scope of the invention.

The invention we claim is:

1. A method for moving and lifting an object relative to a supporting surface, comprising:
providing a fork;
mounting a detachable roller housing to the fork, wherein the detachable roller housing comprises:
at least one upper roller capable of contact with an object; and
at least one lower roller capable of contact with a portion of the at least one upper roller and a supporting surface;
securing the detachable roller housing to the fork; and
positioning the at least one upper roller adjacent to the object, wherein rotation of the at least one lower roller against the supporting surface causes rotation of the at least one upper roller with respect to the object.

2. The method of claim 1, wherein positioning the at least one upper roller adjacent to an object comprises moving a portion of the rolling housing beneath a portion of the object.

3. The method of claim 1, wherein positioning the at least one upper roller adjacent to an object comprises moving a plurality of upper rollers beneath a portion of the object.

4. The method of claim 1, wherein positioning the at least one upper roller adjacent to an object comprises rotating the at least one upper roller in an opposing direction to the at least one lower roller.

5. The method of claim 1, wherein the fork comprises at least one of the following: a platen associated with a fork lift, a platen associated with a pallet fork jack, or a platen associated with a lifting device.

6. The method of claim 1, wherein the at least one upper roller comprises a plurality of upper rollers, and the at least one lower roller comprises a plurality of lower rollers.

7. The method of claim 1, wherein the fork further comprises at least one retaining device adapted to maintain the position of the fork with respect to the detachable roller housing.

8. The method of claim 7, wherein the at least one retaining device is adapted to mount to at least one of the following: the detachable roller housing, or the fork.

9. The method of claim 8, wherein securing the detachable roller housing to the fork comprises at least one of the following: mounting the retaining device to the detachable roller housing, mounting the retaining device to the fork, or mounting the retaining device to both the detachable roller housing and the fork.

10. The method of claim 7, wherein the at least one retaining device comprises at least one of the following: at least one retaining bolt, an angled retaining component.

11. The method of claim 1, further comprising:
elevating the fork and detachable roller housing, wherein the object can be moved away from the supporting surface.

12. A lifting fork, comprising:
at least one fork; and
a detachable roller housing adapted to mount to the at least one fork, the detachable roller housing comprising
at least one upper roller capable of contact with an object; and
at least one lower roller capable of contact with a portion of the at least one upper roller and a supporting surface, wherein rotation of the at least one lower roller causes rotation of the at least one upper roller with respect to the object; and
a retaining device adapted to secure the at least one fork with respect to the detachable roller housing.

13. The lifting fork of claim 12, wherein the at least one fork comprises at least one of the following: a platen associated with a fork lift, a platen associated with a pallet forkjack, or a platen associated with a lifting device.

14. The lifting fork of claim 12, wherein the at least one upper roller comprises a plurality of upper rollers, and the at least one lower roller comprises a plurality of lower rollers.

15. The lifting fork of claim 12, wherein the retaining device comprises at least one of the following: at least one retaining bolt.

16. The lifting fork of claim above, wherein the at least one retaining bolt is adapted to mount to the detachable roller housing.

17. An apparatus for adapting a lifting platen to move and lift an object above a supporting surface, comprising:
a detachable roller housing adapted to mount to at least one lifting platen, the detachable roller housing comprising
a plurality of set of rollers, wherein each set of rollers comprises:
at least one upper roller capable of contact with an object; and
at least one lower roller capable of contact with a portion of the at least one upper roller and a supporting surface, wherein rotation of the at least one lower roller against the supporting surface causes rotation of the at least one upper roller with respect to the object; and
at least one retaining device adapted to secure the detachable roller housing to the at least one lifting platen.

18. The apparatus of claim 17, wherein the detachable roller housing is further adapted to be removed from the lifting platen.

19. The apparatus of claim 17, wherein the lifting platen comprises at least one of the following: a platen associated with a fork lift, a platen associated with a pallet fork jack, or a platen associated with a lifting device.

20. The apparatus of claim 17, wherein the at least one retaining device is adapted to mount to at least one of the following: the detachable roller housing, or the fork.

21. The apparatus of claim 17, wherein securing the detachable roller housing to the fork comprises at least one of the following: mounting the retaining device to the detachable roller housing, mounting the retaining device to the fork, or mounting the retaining device to both the detachable roller housing and the fork.

22. The apparatus of claim 17, wherein the at least one retaining device comprises at least one of the following: at least one retaining bolt, an angled retaining component.

23. A method for using an apparatus for adapting a lifting platen to move and lift an object relative to a supporting surface, comprising:
providing a lifting platen;
providing a detachable roller housing adapted to mount to the lifting platen, the detachable roller housing comprising
a plurality of set of rollers, wherein each set of rollers comprises:
at least one upper roller capable of contact with an object; and
at least one lower roller capable of contact with a portion of the at least one upper roller and a supporting surface, wherein rotation of the at least one lower roller against the supporting surface causes rotation of the at least one upper roller with respect to the object; and
at least one retaining device adapted to secure the detachable roller housing to the at least one lifting platen; and
mounting the detachable roller housing to the lifting platen, wherein an object can be moved adjacent to the lifting platen and detachable roller housing.

24. The method of claim 23, wherein the lifting platen comprises at least one of the following: a platen associated with a fork lift, a platen associated with a pallet fork jack, or a platen associated with a lifting device.

25. The method of claim 23, wherein the at least one retaining device is adapted to mount to at least one of the following: the detachable roller housing, or the lifting platen.

26. The method of claim 23, further comprising:
securing the detachable roller housing to the at least one lifting platen.

27. The method of claim 26, wherein securing the detachable roller housing to the at least one lifting platen comprises at least one of the following: mounting the retaining device to the detachable roller housing, mounting the retaining device to the fork, or mounting the retaining device to both the detachable roller housing and the fork.

28. The method of claim 23, wherein the at least one retaining device comprises at least one of the following: at least one retaining bolt, an angled retaining component.
